(19) United States
(12) Patent Application Publication
(10) Pub. No.: US 2002/0002757 A1
(43) Pub. Date: Jan. 10, 2002

(54) Double hinge console latch

(76) Inventors: Eric D. Hyp, Aspers, PA (US); Loc B. Tieu, Exton, PA (US)

Correspondence Address: Paul & Paul, 2900 Two Thousand Market Street, Philadelphia, PA, 19103, US

(21) Appl. No.: 09/855,339

(22) Filed: May 15, 2001

Related U.S. Application Data
(60) Provisional application No. 60/204,290, filed on May 15, 2000.
(60) Provisional application No. 60/210,928, filed on Jun. 12, 2000.
(60) Provisional application No. 60/218,920, filed on Jul. 18, 2000.
(60) Provisional application No. 60/228,628, filed on Aug. 29, 2000.

(51) Int. Cl. E05D 7/04

(52) U.S. Cl. 16/243

(57) ABSTRACT

The double hinged latch is an ambidextrous latch having corresponding activation means substantially parallel on either side of a lid substrate. During activation, a slide member drives a rotary linkage, which in turn disengage slide pins from the housing. Simultaneously, a lock link is driven by a rotary link, to secure the opposite rotary link, thereby locking the second side slide pins within the housing thereby being used as hinge. The slide members are biased by a living spring with aperture located therein. Engagement is biased by a compression spring attached to the rotary linkages.

### CROSS-REFERENCE TO RELATED APPLICATION

This application claims priority to U.S. Provisional Application No. 60/204,290 filed May 15, 2000, U.S. Provisional Application No. 60/210,928 filed Jun. 12, 2000, U.S. Provisional Application No. 60/218,920 and U.S. Provisional Application No. 60/228,628 filed Aug. 29, 2000.

### BACKGROUND OF THE INVENTION

1. Field of the Invention

The present invention relates to a latch assembly and more particularly to console latches where an actuation member is depressed to release the latch.

2. Brief Description of the Prior Art

Console latches are generally used to secure the cover of a compartment such as, for example, a console in a vehicle. Often, a console consists of a container, which is swingably hinged between passenger seats to swing out of the way when the vehicle operator or passenger desires. Often, the consoles can store objects therein such as loose change, sunglasses, maps, pens, paper and other articles, which the driver and/or passengers may find it necessary to use.

It is desirable to maintain the console cover in a closed position to secure contents therein when the vehicle is being operated. It is also desirable to lift the console from a horizontal position to a vertical position in order to have access to the contents within the console, such that the console may be lifted from either the driver's side or the passenger's side, with the opening capable of facing both the driver's direction and the passenger's direction. It is known to provide a depressible latching device, which can secure a console lid to the console body and be opened as the vehicle operator or passenger desires by depression of a latch button.

There are, however, console latches, which employ more complex configurations than simply a cover or lid and console body. These console latches are often provided in intricate designs, with several individual parts, each of which must be separately manufactured and combined into one console lid unit. Thus, these intricate designs are often very expensive to manufacture and add to the overall cost of the vehicle. Moreover, in the event that the console lid is removed from the console body, reinstallation of the lid becomes very difficult as a result of trying to engage the several independent parts together and at the same time.

A need, therefore, exists for an improved latch, which can selectively regulate the opening and closing of a first console compartment, and which is constructed out of high strength material and of a simpler design than is currently available, and at a much lower manufacturing cost.

### SUMMARY OF THE INVENTION

The present invention provides for a novel latch assembly, which can secure a closure cover to a compartment body. The latch of the present invention is a double hinge latch, whereby, the left side (or driver side) is the mirror image of the right side (or passenger side). The latch assembly has a lid substrate, which has molded elements for housing or securing various sub elements of the latch assembly. The latch assembly includes four slide pins, two mounted on the driver side, and two mounted on the passenger side. Each slide pin carries a pin member for engagement with a pair of keepers, which can be provided in the panel or bin of the console. An actuation member, such as a button, is connected to the slide member and is disposed for depression by an operator to actuate the latch. The actuation with the button moves the pins rearward with respect to the panel and out of engagement with the keepers. The actuation buttons are provided to be actuated on the front side of the console, with one button closer to the driver side, and one button closer to the passenger side. The latch assembly preferably includes an rotary link, which is actuates a lock link providing articulation between the driver's side components with the passenger's side components. The button includes a living spring component to facilitate returning of the button to its original position, once the console lid is returned to the closed position. The assembly is provided on both the driver's side and the passenger's side in order to allow the console lid to be opened in both directions. As such, when one assembly is used to open the lid from one side, the opposite mirror assembly acts as a hinge and allows for opening and closing of the console lid. The lock link allows the driver's side to be opened, while the passenger's side remains locked. Conversely, the lock link allows the passenger's side to be opened, while the driver's side remains locked.

It is an object of the present invention to provide a latch, which is useful for securing a console in a vehicle.

It is another object of the present invention to provide a latch, which includes a living spring member, which allows for the latch and button to return to their original position once it is released and the console lid is returned to the closed position.

It is another object of the present invention to provide a keeper member, which has a latching accommodating element for securing a pin

Still another object of the present invention is to provide for a mirrored pair of latch assemblies such that each side of the console comprises the same assembly as the other side.

It is another object of the present invention to provide a latch, which includes a rotary link and lock link, which allows one side of the console lid to be opened, while the other side stays locked.

Still another object of the present invention is to provide a latch, which is easily mounted in the console body and can easily accommodate the console lid.

Another object of the present invention is to provide a latch, which is designed relatively simply, yet can perform its function properly.

### BRIEF DESCRIPTION OF THE DRAWINGS

FIG. 1 is a perspective view of the double-hinge console latch assembly in the neutral position according to the present invention.

FIG. 2 is a top plan view of the double-hinge console latch assembly of FIG. 1 in the neutral position.

FIG. 3 is an alternate top plan view of the double-hinge console latch assembly of FIG. 1 in the neutral position.

FIG. 4 is a left side elevation view of the double-hinge console latch assembly of FIG. 3 in the neutral position cut along line B-B of FIG. 3.

FIG. 5 is a magnified view of the double-hinge console latch assembly of FIG. 4.

FIG. 6 is a rear elevation view of the double-hinge console latch assembly of FIG. 1 in the neutral position.

FIG. 7 is a left side elevation view of the double-hinge console latch assembly of FIG. 1 in the neutral position.

FIG. 8 is a perspective view of the double-hinge console latch assembly in the driver semi-open position according to the present invention.

FIG. 9 is a top plan view of the double-hinge console latch assembly of FIG. 8 in the driver semi-open position.

FIG. 10 is an alternate top plan view of the double-hinge console latch assembly of FIG. 8 in the driver semi-open position.

FIG. 11 is a left side elevation view of the double-hinge console latch assembly of FIG. 10 in the driver semi-open position cut along line A-A of FIG. 10.

FIG. 12 is a magnified view of the double-hinge console latch assembly of FIG. 11.

FIG. 13 is a rear elevation view of the double-hinge console latch assembly of FIG. 8 in the driver semi-open position.

FIG. 14 is a left side elevation view of the double-hinge console latch assembly of FIG. 8 in the driver semi-open position.

FIG. 15 is a perspective view of the double-hinge console latch assembly in the driver open position according to the present invention.

FIG. 16 is a top plan view of the double-hinge console latch assembly of FIG. 15 in the driver open position.

FIG. 17 is an alternate top plan view of the double-hinge console latch assembly of FIG. 15 in the driver open position.

FIG. 18 is a left side elevation view of the double-hinge console latch assembly of FIG. 17 in the driver open position cut along line C-C of FIG. 17.

FIG. 19 is a magnified view of the double-hinge console latch assembly of FIG. 18.

FIG. 20 is a rear elevation view of the double-hinge console latch assembly of FIG. 15 in the driver open position.

FIG. 21 is a left side elevation view of the double-hinge console latch assembly of FIG. 15 in the driver open position.

FIG. 22 is a perspective view of the double-hinge console latch assembly in the passenger open position according to the present invention.

FIG. 23 is a top plan view of the double-hinge console latch assembly of FIG. 22 in the passenger open position.

FIG. 24 is a rear elevation view of the double-hinge console latch assembly of FIG. 22 in the passenger open position.

FIG. 25 is a left side elevation view of the double-hinge console latch assembly of FIG. 22 in the passenger open position.

FIG. 26 is a perspective view of the lid substrate according to the present invention.

FIG. 27 is a top plan view of the lid substrate of FIG. 26.

FIG. 28 is a rear elevation view of the lid substrate of FIG. 26.

FIG. 29 is a left side elevation view of the lid substrate of FIG. 26.

FIG. 30 is a perspective view of the slide pin according to the present invention.

FIG. 31 is a top plan view of the slide pin of FIG. 30.

FIG. 32 is a left side elevation view of the slide pin of FIG. 30.

FIG. 33 is a front elevation view of the slide pin of FIG. 30.

FIG. 34 is a right side elevation view of the slide pin of FIG. 30.

FIG. 35 is a bottom plan view of the slide pin of FIG. 30.

FIG. 36 is a rear elevation view of the slide pin of FIG. 30.

FIG. 37 is a perspective view of the rotary link according to the present invention.

FIG. 38 is a top plan view of the rotary link of FIG. 37.

FIG. 39 is a left side elevation view of the rotary link of FIG. 37.

FIG. 40 is a front elevation view of the rotary link of FIG. 37.

FIG. 41 is a right side elevation view of the rotary link of FIG. 37.

FIG. 42 is a rear elevation view of the rotary link of FIG. 37.

FIG. 43 is a bottom plan view of the rotary link of FIG. 37.

FIG. 44 is a perspective view of the button according to the present invention.

FIG. 45 is a top plan view of the button of FIG. 44.

FIG. 46 is a front elevation view of the button of FIG. 44.

FIG. 47 is a left side elevation view of the button of FIG. 44.

FIG. 48 is a rear elevation view of the button of FIG. 44 .

FIG. 49 is a bottom plan view of the button of FIG. 44.

FIG. 50 is a right side elevation view of the button of FIG. 44.

FIG. 51 is a rotated top view of the double-hinge console latch assembly in the neutral position according to the present invention.

FIG. 52 is a magnified view of the double-hinge console latch assembly of FIG. 51.

FIG. 53 is a rotated top view of the double-hinge console latch assembly in the driver semi-open position according to the present invention.

FIG. 54 is a magnified view of the double-hinge console latch assembly of FIG. 53.

FIG. 55 is a perspective view of the angled trigger according to the present invention.

FIG. 56 is a top plan view of the angled trigger of FIG. 55.

FIG. 57 is a front elevation view of the angled trigger of FIG. 55.

FIG. 58 is a left side elevation view of the angled trigger of FIG. 55.

FIG. 59 is a rear elevation view of the angled trigger of FIG. 55.

FIG. 60 is a right side elevation view of the angled trigger of FIG. 55.

FIG. 61 is a bottom plan view of the angled trigger of FIG. 55.

FIG. 62 is a perspective view of the extension spring according to the present invention.

FIG. 63 is a top plan view of the extension spring of FIG. 62.

FIG. 64 is a left side elevation view of the extension spring of FIG. 62.

FIG. 65 is a front elevation view of the extension spring of FIG. 62.

FIG. 66 is a right side elevation view of the extension spring of FIG. 62.

FIG. 67 is a rear elevation view of the extension spring of FIG. 62.

FIG. 68 is a bottom plan view of the extension spring of FIG. 62.

FIG. 69 is a perspective view of the lock link according to the present invention.

FIG. 70 is a top plan view of the lock link of FIG. 69.

FIG. 71 is a rear elevation view of the lock link of FIG. 69.

FIG. 72 is a right side elevation view of the lock link of FIG. 69.

FIG. 73 is a front side elevation view of the lock link of FIG. 69.

FIG. 74 is a left side elevation view of the lock link of FIG. 69.

FIG. 75 is a bottom plan view of the lock link of FIG. 69.

FIG. 76 is a perspective view of the lock link compression spring according to the present invention.

FIG. 77 is a right side elevation view of the lock link compression spring of FIG. 76.

FIG. 78 is a rear elevation view of the lock link compression spring of FIG. 76.

FIG. 79 is a top plan view of the lock link compression spring of FIG. 76.

FIG. 80 is a left side elevation view of the lock link compression spring of FIG. 76.

FIG. 81 is a bottom plan view of the lock link compression spring of FIG. 76.

FIG. 82 is a front elevation view of the lock link compression spring of FIG. 76.

### DETAILED DESCRIPTION OF THE PREFERRED EMBODIMENTS

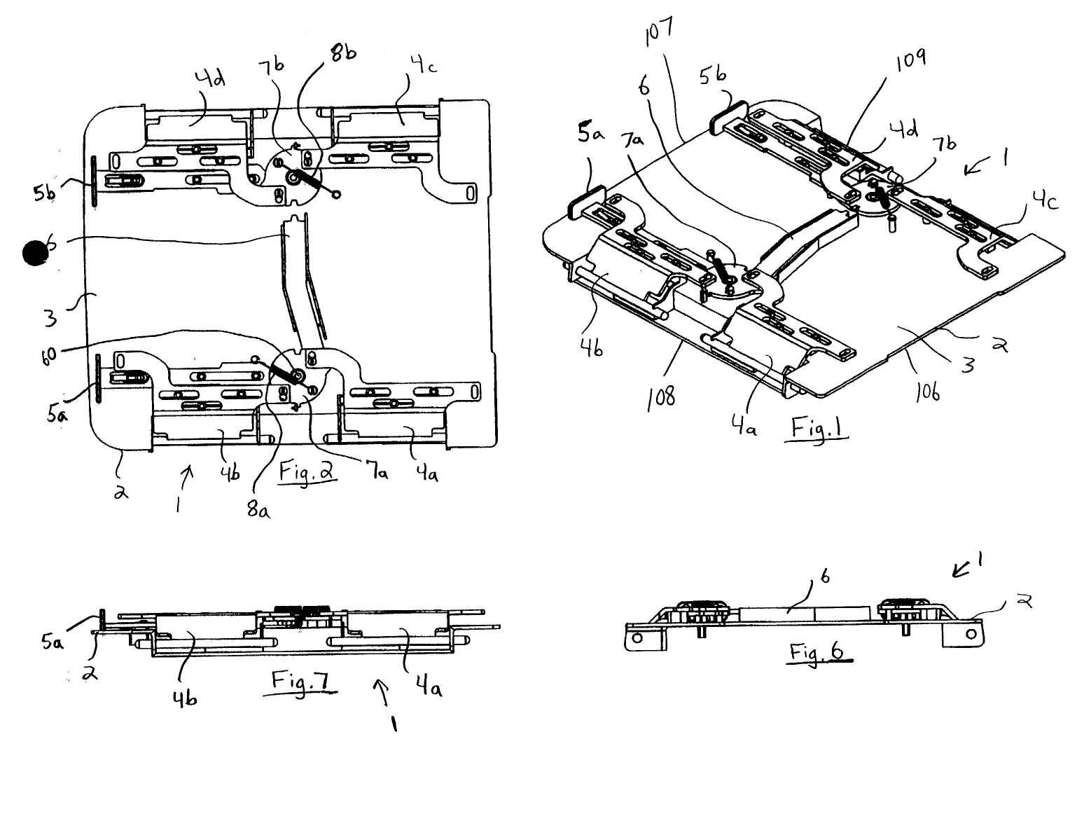

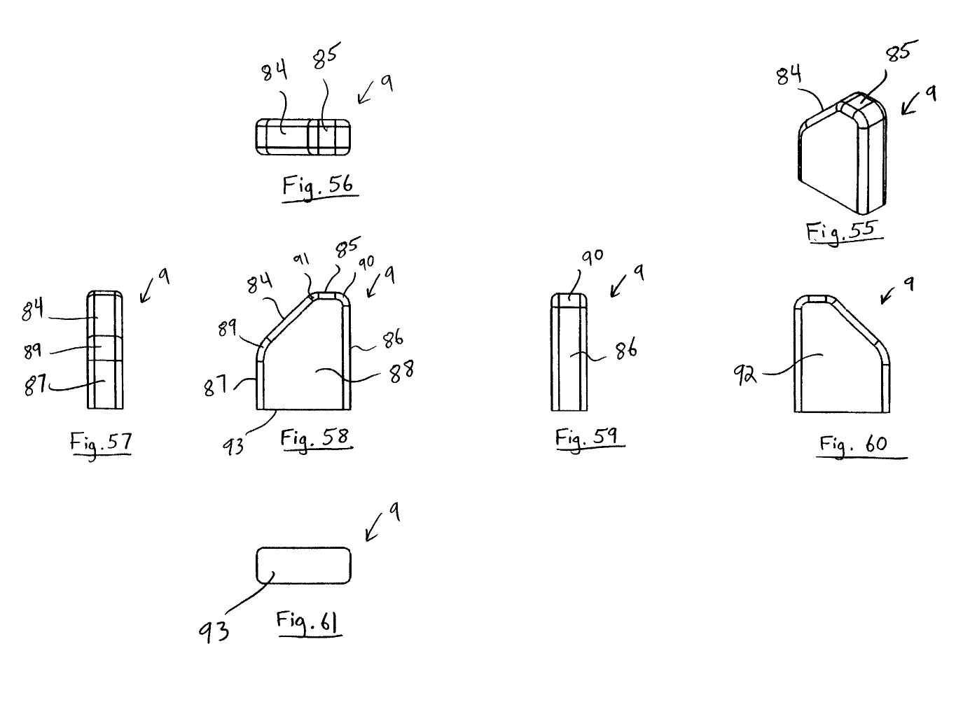

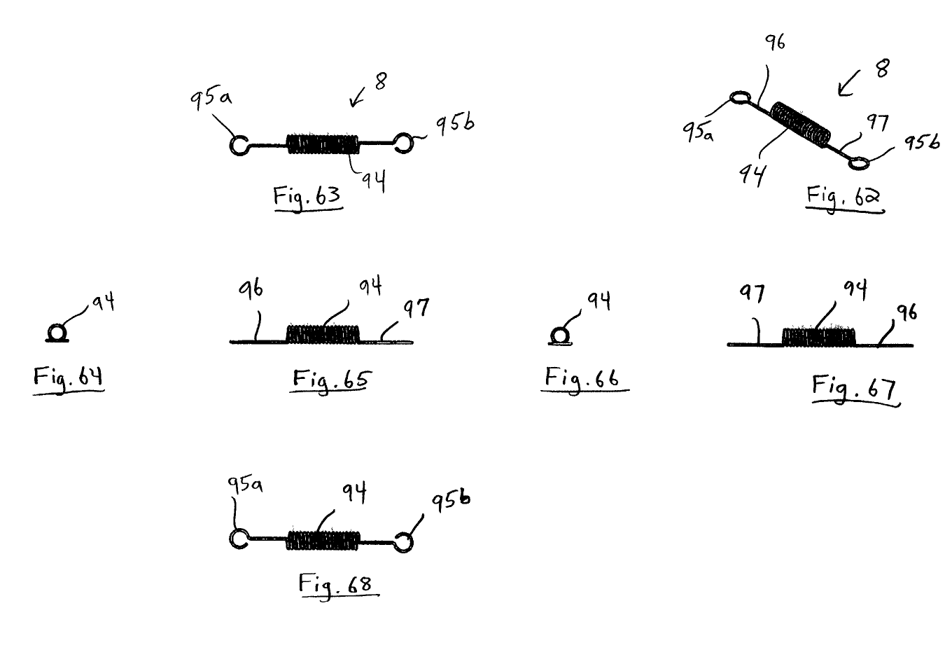

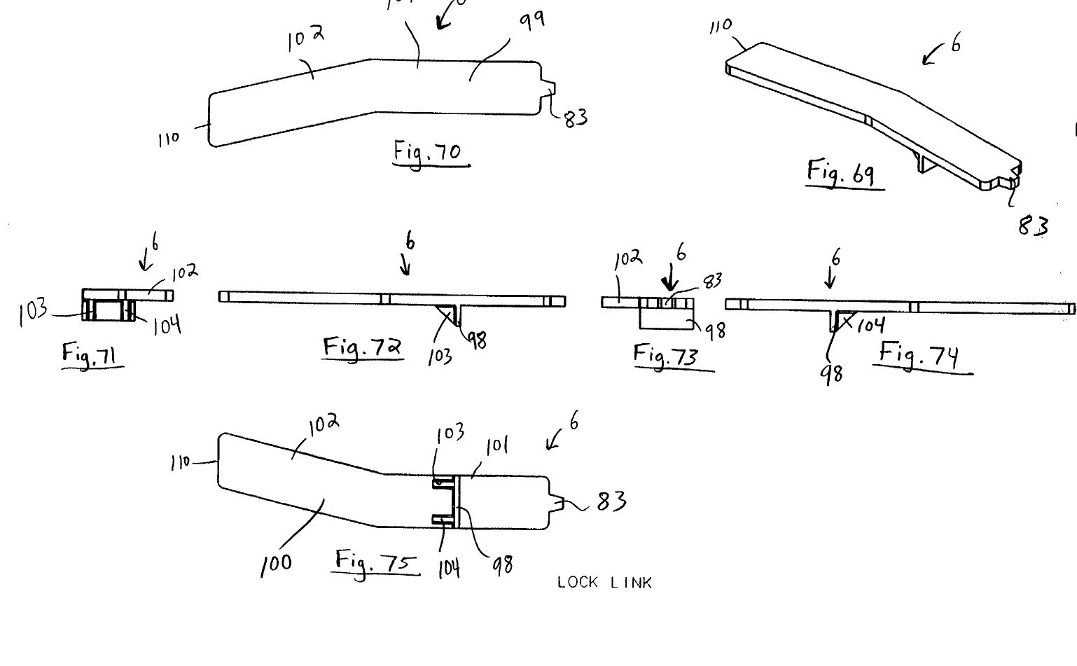

Reference now being made to FIGS. 1-7, where a double-hinge console latch 1 is shown in alternative views. In FIGS. 1-7, the double-hinge console latch 1 is shown in a neutral position. The double-hinge console latch assembly 1 comprises a front end 107; a back end 106; a driver's side 108; a passenger's side 109; a lid substrate 2; a plurality of slide pins 4, designated in the preferred embodiment as four slide pins shown as slide pin 4a, 4b, 4c, 4d; a plurality of buttons 5, designated in the preferred embodiment as two buttons shown as button 5a, 5b; a lock link 6, a plurality of rotary links 7, designated in the preferred embodiment as two lock links shown as rotary link 7a, 7b; a plurality of extension springs 8, designated in the preferred embodiment as two extension springs shown as extension spring 8a, 8b; and a plurality of angled triggers 9, designated in the preferred embodiment as two angled triggers 9a (shown) and 9b (not shown). The double-hinge console latch is shown comprising a driver's side and a passenger's side, wherein the passenger's side mirrors the driver's side. The lid substrate 2 connects to the buttons 5a, 5b, which are connected to the slide pins 4b, 4d respectively. The slide pins 4b, 4d are connected to the rotary links 7a, 7b respectively, which are connected to the lid substrate 2. The rotary links 7a, 7b are also connected to slide pins 4a, 4c respectively.

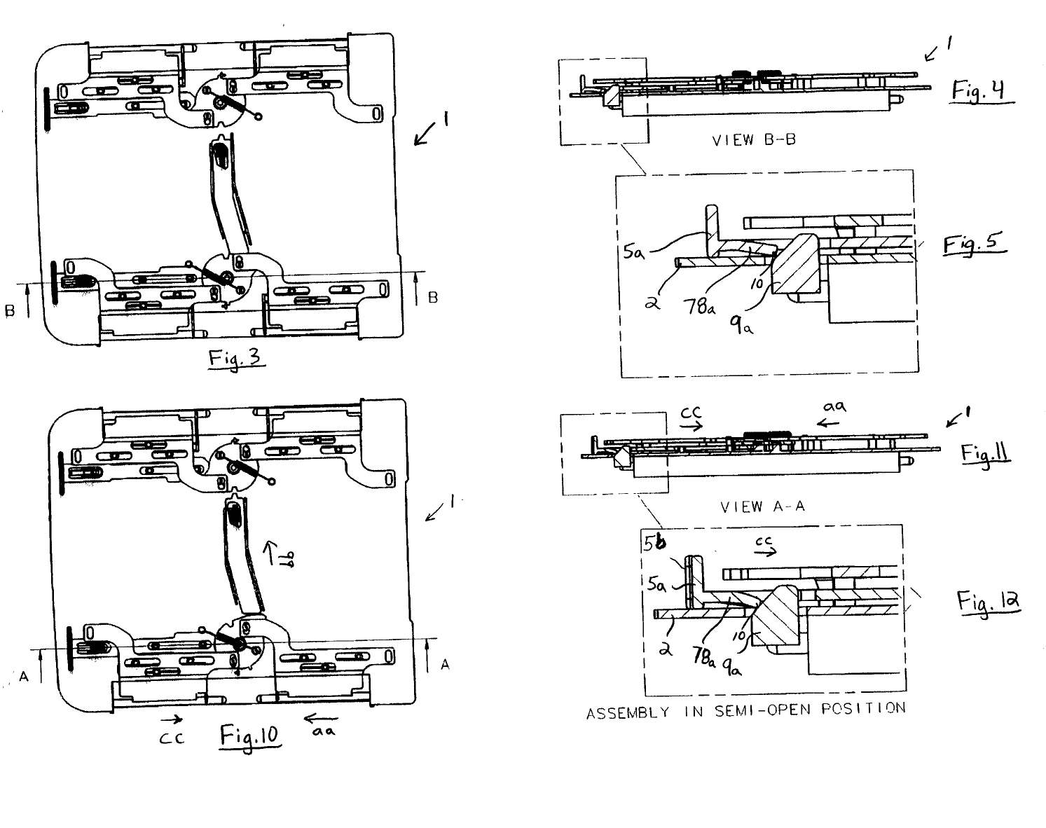

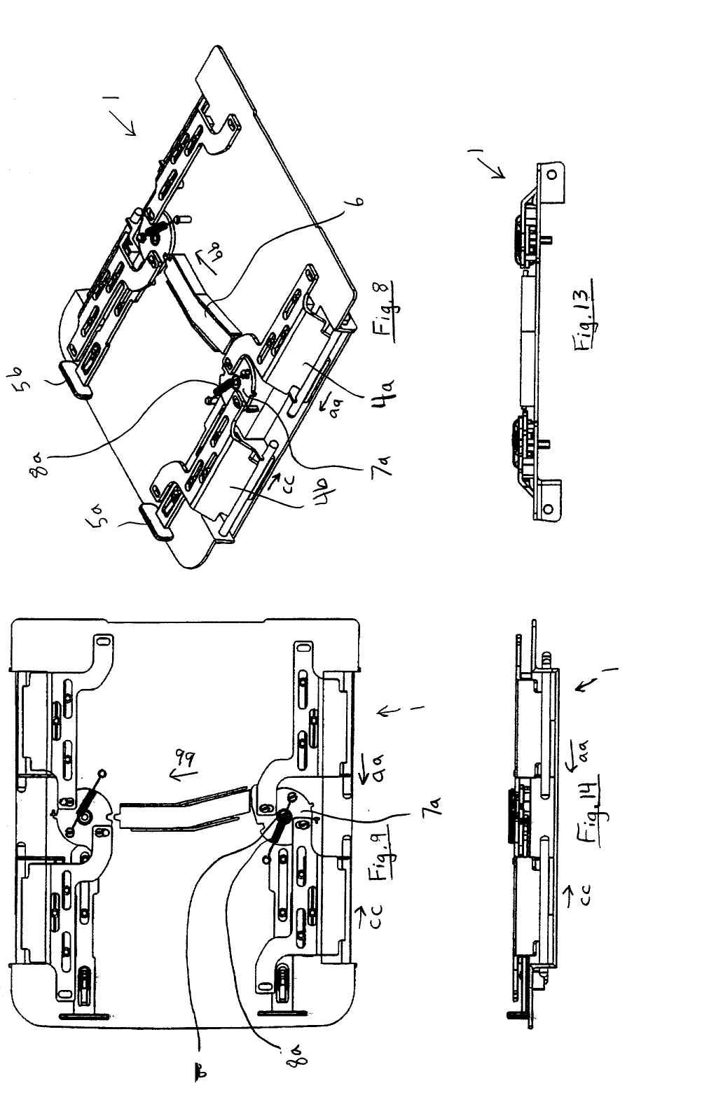

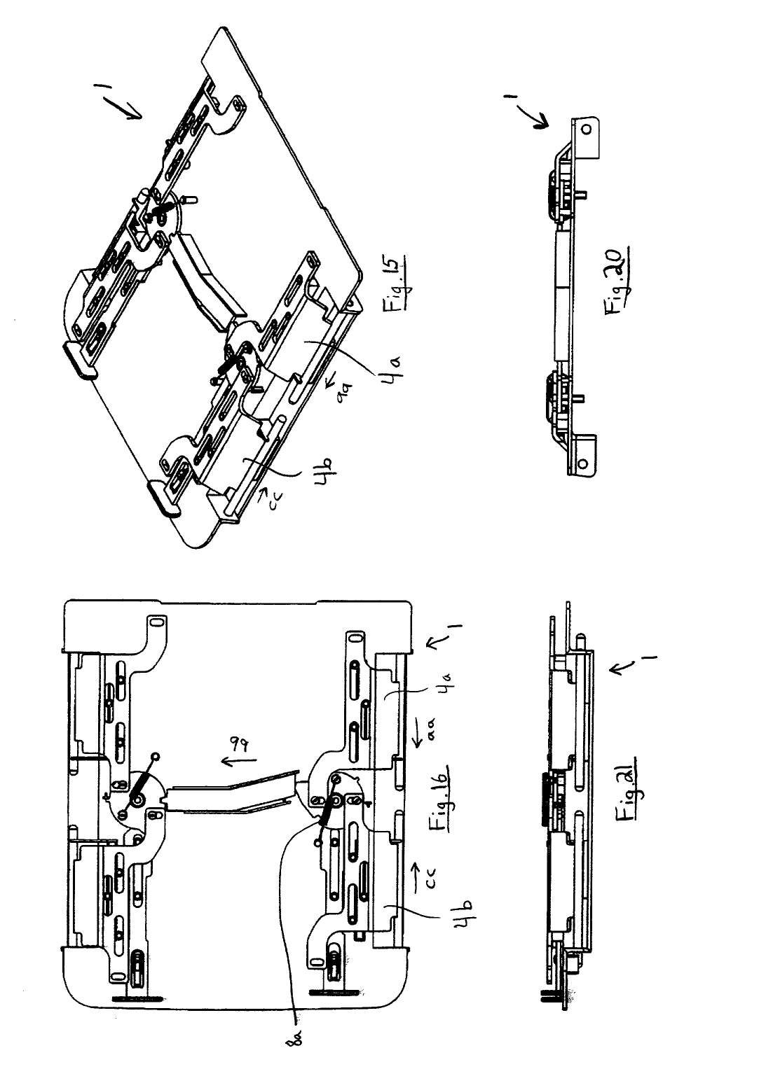

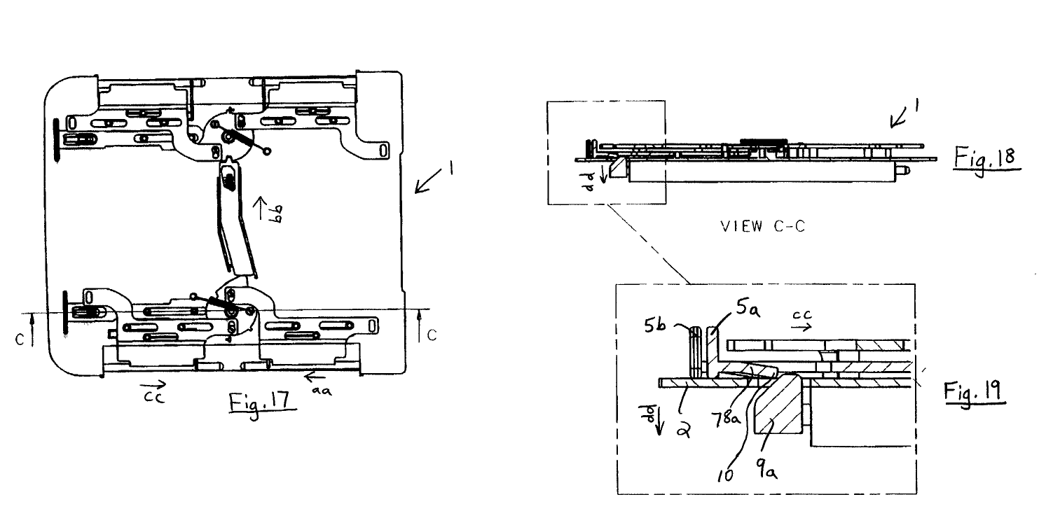

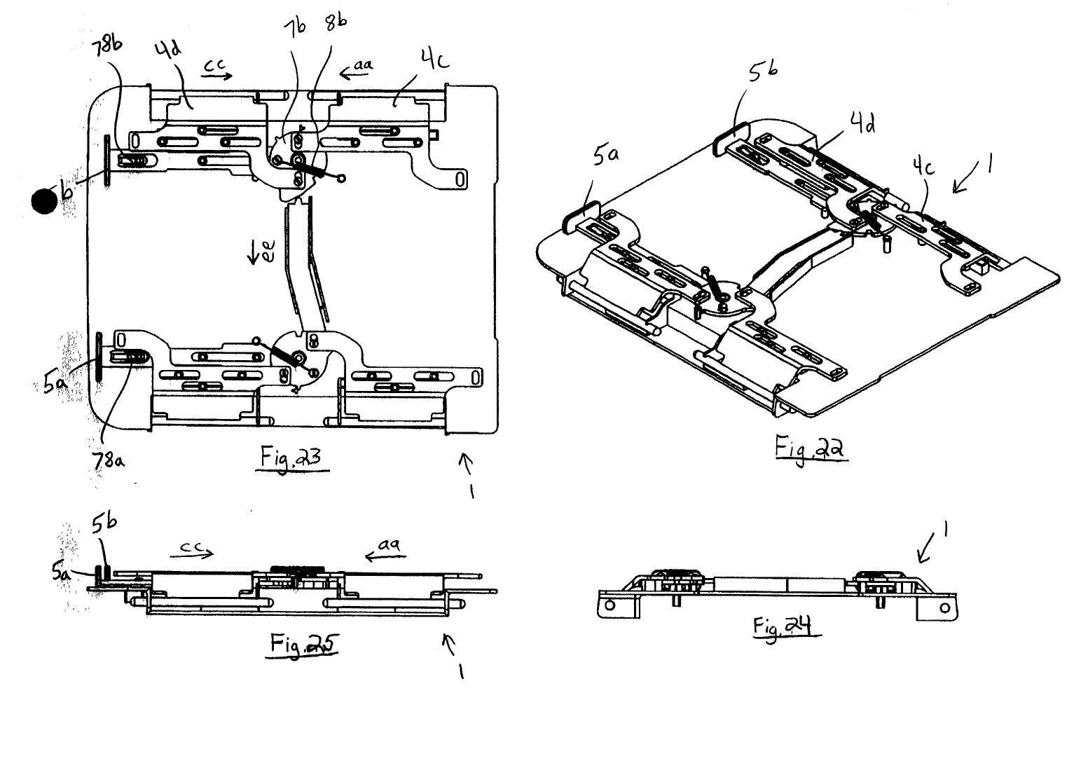

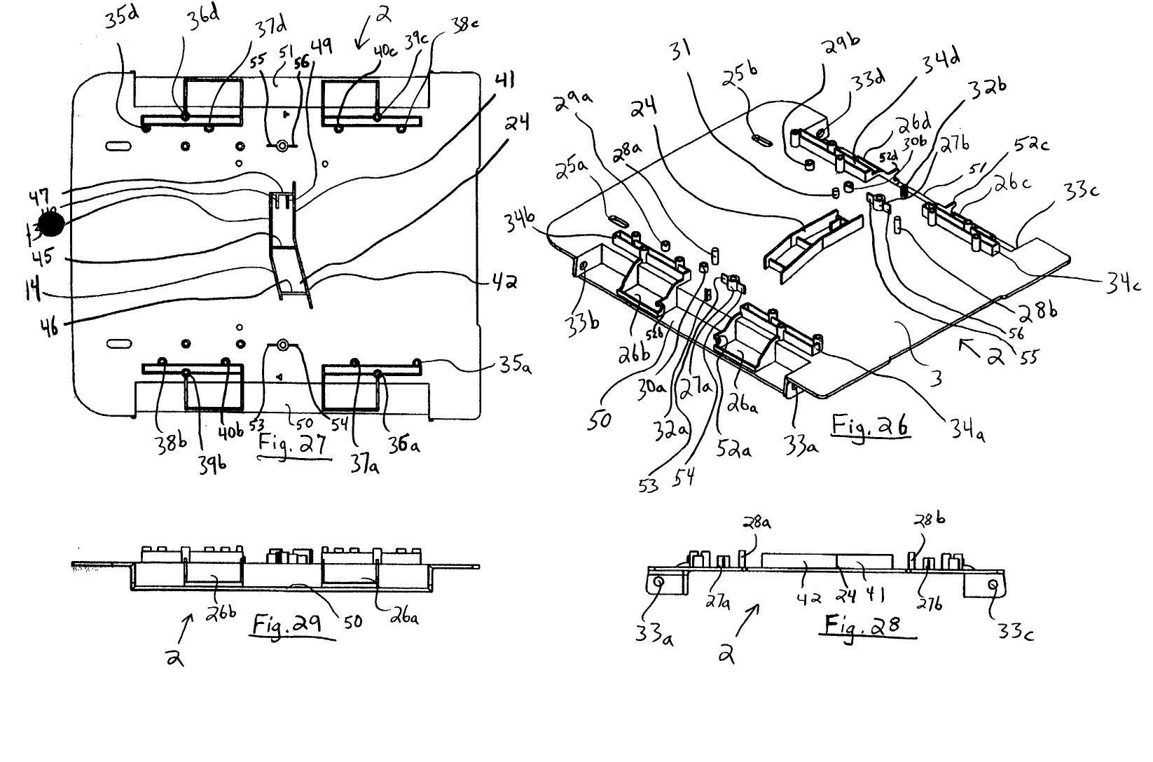

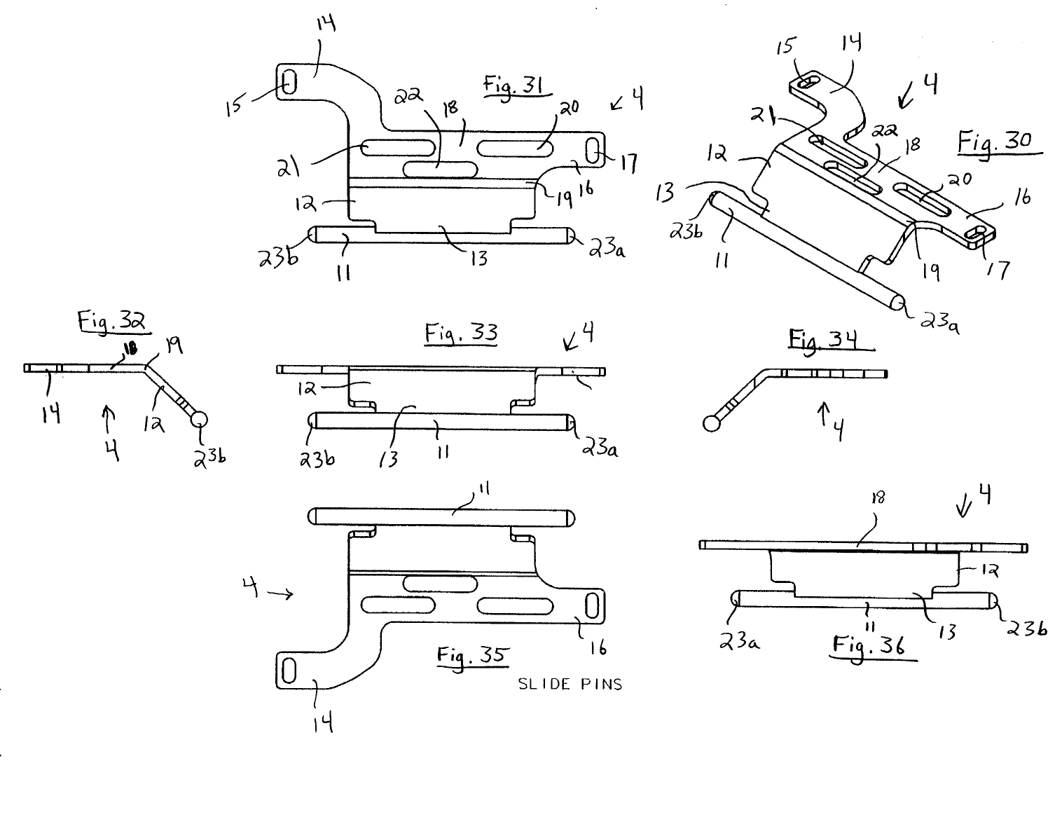

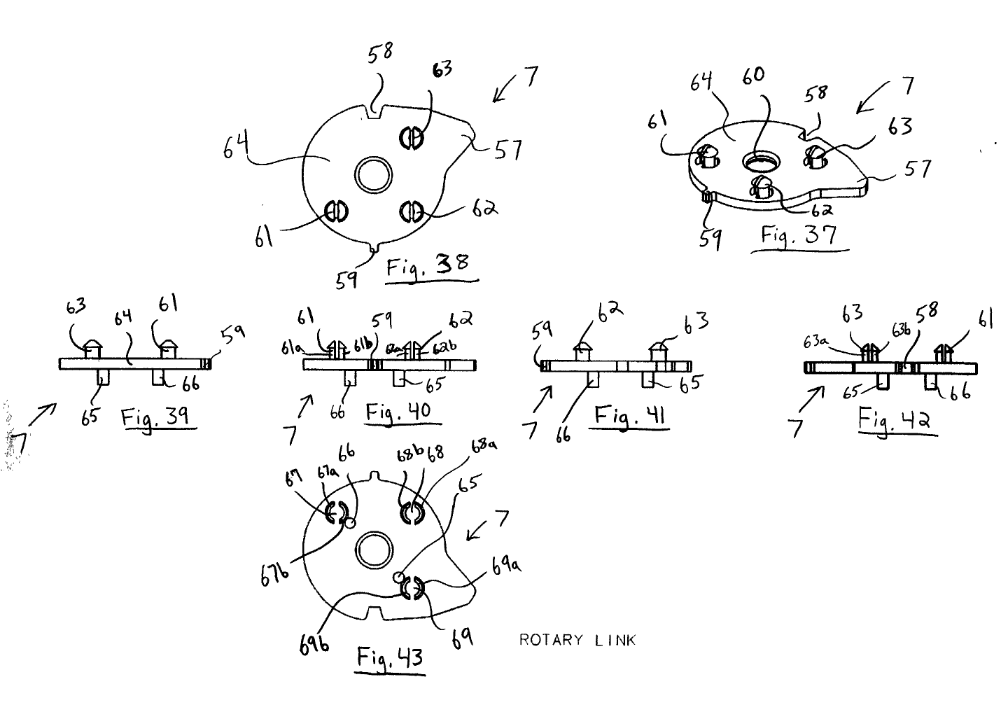

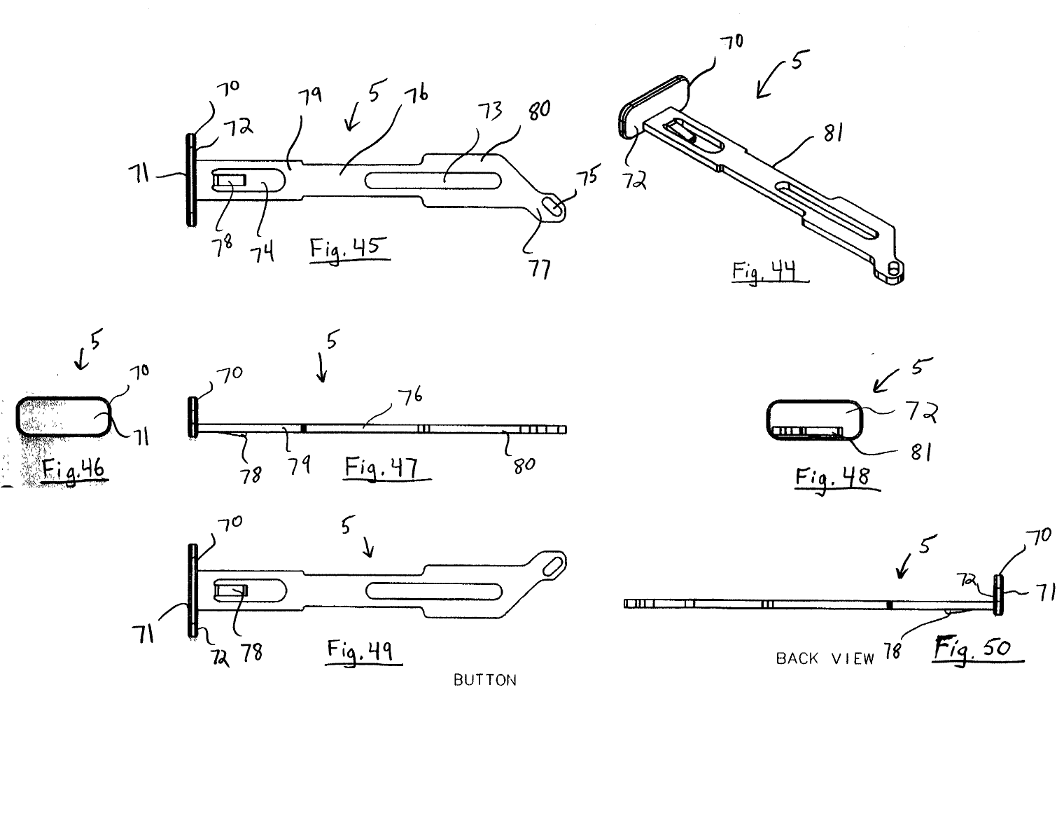

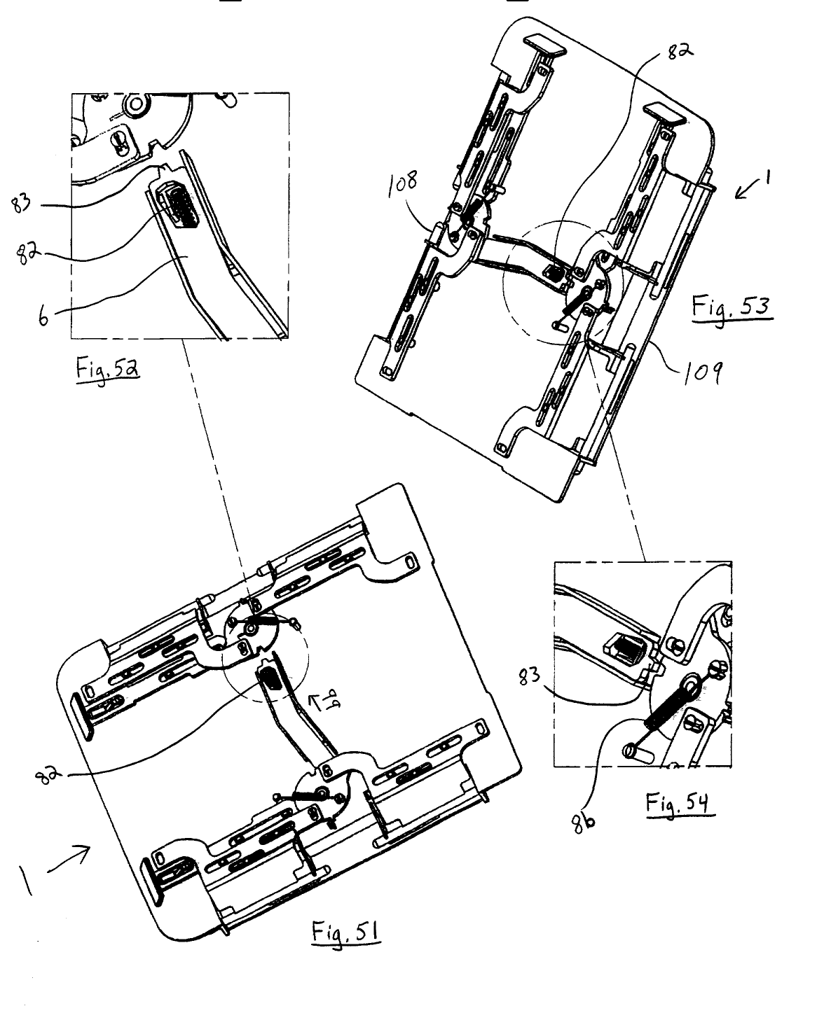

In the neutral position, as shown in FIGS. 1-7, neither the driver's side button 5a, nor the passenger's side button 5b have been actuated, and in the neutral position a console lid (not shown) which would mount directly on top of the latch assembly would be in a closed position. FIG. 4 shows a left side view cut along line B-B of FIG. 3. In the magnified view shown in FIG. 5, the driver's side button 5a is shown. In this neutral position, a living spring 78a attached to the button 5a is shown. The living spring 78a terminates at a contact end 10, wherein said living spring is capable of flexing. Also shown in FIG. 5 is the angled trigger 9a, wherein said angled trigger 9a is fixably attached to a console bin (not shown).

Next, reference is made to FIGS. 8-14, which shows the driver's side button 5a being actuated, thus the latch assembly is said to be in a driver semi-open position. In these views, the button 5a is actuated, thereby causing lateral movement of button 5a in a direction cc. This lateral movement causes lateral movement of slide pin 4b also in the direction cc. This lateral movement further causes said rotary link 7a to rotate counter-clockwise, thereby causing said lock link 6 to move in a direction bb towards the passenger's side, and also causing slide pin 4a to move in a direction aa. An extension spring 8, shown on the driver's side as 8a, attaches said rotary link 7a to the lid substrate 2, whereby rotational movement of said rotary link 7a causes said extension spring 8 to extend or expand. In FIG. 2, the extension springs 8a, 8b shown, are in the neutral position, thus there is no expansion or extension of said extension springs 8a, 8b. Furthermore, in this position, said extension springs 8a, 8b do not cross a center hole 60 in the rotary links 7a, 7b, and said extension springs 8a, 8b remain on a side closer to the driver's side and passenger's side respectively. However, in FIG. 9, extension spring 8a is shown in a state of extension, such that said extension spring 8a begins to articulate across the center hole 60 of the rotary link 7a. FIG. 12 shows a magnified view of FIG. 11, which is a left side elevation view of the latch assembly in the semi-open position. In FIG. 12, it is seen that button 5a is actuated in a direction cc. It can be seen that button 5b remains in the neutral position. In the driver semi-open position, the living spring 78a begins to flexibly bend such that contact end 10 is in full contact with the angled trigger 9a. Thus, angled trigger 9a creates a trigger force upon contact end 10, thus causing the living spring 78a to bend.

Referring now to FIGS. 15-21, shows the driver's side button 5a being fully actuated, thus the latch assembly is said to be in a driver open position. In these views, the button 5a is fully actuated, thereby causing full lateral movement of slide pin 4b in a direction cc, and full lateral movement of slide pin 4a in a direction aa. This full lateral movement further causes said rotary link 7a to further rotate counter-clockwise, thereby causing said lock link 6 to move further in a direction bb towards the passenger's side. An extension spring 8, shown on the driver's side as 8a, attaches said rotary link 7a to the lid substrate 2, whereby rotational movement of said rotary link 7a causes said extension spring 8 to extend or expand. In FIG. 16, extension spring 8a is shown in a state of full extension, such that said extension spring 8a articulates across the center hole 60 of the rotary link 7a. FIG. 19 shows a magnified view of FIG. 18, which is a left side elevation view of the latch assembly in the driver open position. In FIG. 19, it is seen that button 5a is fully actuated in a direction cc. It can be seen that button 5b remains in the neutral position. In the driver open position, the living spring 78a is no longer in contact with the angled trigger 9a. Thus, angled trigger 9a has articulated in a direction dd, and the latch assembly remains in this driver open position, until the console lid, including the latch assembly, is closed by slam-action, which returns the button 5a back into the neutral position.

Reference is now made to FIGS. 22-25. In these figures, the passenger's side button 5b being fully actuated, thus the latch assembly is said to be in a passenger open position. In these views, the button 5b is fully actuated, thereby causing full lateral movement of slide pin 4d in a direction cc, and full lateral movement of slide pin 4c in a direction aa. This full lateral movement further causes the rotary link 7b to rotate counter-clockwise, thereby causing said lock link 6 to move further in a direction ee towards the driver's side. The extension spring 8, shown on the passenger's side as 8b, attaches said rotary link 7b to the lid substrate 2, whereby rotational movement of said rotary link 7b causes said extension spring 8 to extend or expand. In FIG. 23, extension spring 8b is shown in a state of full extension, such that said extension spring 8b articulates across the center hole 60 of the rotary link 7b. It can be best seen in FIG. 25 that button 5b is fully actuated in a direction cc, while button 5a remains in the neutral position. Although not shown, in the passenger open position, the living spring 78b is no longer in contact with the angled trigger 9b. Thus, angled trigger 9b has articulated in a direction dd, and the latch assembly remains in this passenger open position, until the console lid, including the latch assembly, is closed by slam-action, which returns the button 5b back into the neutral position.

FIGS. 30-35 detail the slide pin 4. Slide pin 4 further comprises a generally rectangular middle portion 18, with an elongated tail portion 16, and a protruding neck portion 14. A curved mid section 19 connects the rectangular middle portion 18 to a generally sloped portion 12, which terminates at a slightly tapered bottom portion 13, which connects to the pin 11. Pin 11 terminates with a pair of rounded ends 23a, 23b located on opposite sides. The generally rectangular middle portion 18 of the slide pin 4 further includes three generally elongated eyelet holes 20, 21, 22. The tail portion 16 includes an eyelet hole 17, and the protruding neck portion 14 includes an eyelet hole 15.

FIGS. 26-29 show the lid substrate 2. Said lid substrate 2 includes a base 3, which has molded sub-elements fixably attached to it, which are detailed next. A lock link housing 24 is fixably attached on the base in the middle of the lid substrate 2. Said lock link housing 24 comprises a rear straight wall 41, a rear angled wall 42, a front straight wall 43, a front angled wall 44, a driver's side end wall 46, a middle catch wall 45, and a passenger's side end wall 47. Said passenger's side end wall 47 comprises two protruding guides 48, 49 which are perpendicular to said passenger's side end wall 47, and are contained within said lock link housing 24. The lid substrate 2 further comprises a pair of living spring holes 25a, 25b, which allow the living springs 78a, 78b to protrude through the lid substrate and catch with the angled triggers 9a, 9b respectively. The lid substrate 2 further includes a plurality of slide pin housings 26a, 26b, 26c, 26d, which house the slide pins 4a, 4b, 4c, 4d respectively. Moreover, said slide pin housings 26a, 26b, 26c, 26d include a pin groove 52a, 52b, 52c, 52d to slidably guide said slide pins 4a, 4b, 4c, 4d respectively, and a plurality of slide pin holes 33a, 33b, 33c, 33d to slidably guide and catch slide pins 4a, 4b, 4c, 4d respectively. Said slide pin housings 26a, 26b further comprises a base 50; likewise, said slide pin housings 26c, 26d further comprises a base 51.

A pair of rotary center posts 27a, 27b are also fixably mounted to said lid substrate 2, wherein said rotary center posts comprise wings 53, 54 attached to rotary center post 27a, and wings 55, 56 attached to rotary center post 27b. The lid substrate 2 further comprises a pair of extension spring posts 28a, 28b; button guide posts 29a, 30a used to guide button 5a, and corresponding button guide posts 29b, 30b used to guide button 5b; rotary link post 31; rotary link stop post 32a, 32b, which terminate the rotational movement of rotary link 7a, 7b. The lid substrate also includes a plurality of slide pin housing guides 34a, 34b, 34c, 34d, which guide the slide pins 4a, 4b, 4c, 4d respectively. Said slide pin housing guide 34a further comprises a plurality of slide pin guiding posts 35a, 36a, 37a, which protrude through generally elongated eyelet holes 20, 22, 21 respectively of said slide pin 4. Likewise, said slide pin housing guide 34b further comprises a plurality of slide pin guiding posts 38b, 39b, 40b, which protrude through generally elongated eyelet holes 21, 22, 20 respectively of said slide pin 4. Moreover, said slide pin housing guide 34c further comprises a plurality of slide pin guiding posts 38c, 39c, 40c, which protrude through generally elongated eyelet holes 21, 22, 20 respectively of said slide pin 4. Finally, said slide pin housing guide 34d further comprises a plurality of slide pin guiding posts 35d, 36d, 37d, which protrude through generally elongated eyelet holes 20, 22, 21 respectively of said slide pin 4. Thus said slide pin 4 remains guided within said respective slide pin guiding posts described above.

FIGS. 37-43 fully illustrate the rotary link 7. Said rotary link 7, specifically rotary link 7a, 7b, comprises a center hole 60 for mounting on rotary center posts 27a, 27b of lid substrate 2. Wherein said rotary link 7a rests on top of wings 53, 54 attached to rotary center post 27a, and said rotary link 7b rests on top of wings 55, 56 attached to rotary center post 27b. Said rotary link 7 further comprises a link 57; a notch 58; a catch 59; a generally circular cam portion 64; a plurality of snap posts 61, 62, 63; and a pair of legs 65, 66. Wherein, the underside of snap post 61 comprises a base 67 and a pair of semi-circular openings 67a, 67b. Likewise, the underside of snap post 62 comprises a base 68 and a pair of semi-circular openings 68a, 68b. Moreover, the underside of snap post 63 comprises a base 69 and a pair of semi-circular openings 69a, 69b. Furthermore, snap post 61 further comprises a pair of prongs 61a, 61b. Likewise, snap post 62 further comprises a pair of prongs 62a, 62b. Finally, snap post 63 further comprises a pair of prongs 63a, 63b. The semicircle openings 67a, 67b, 68a, 68b, 69a, 69b allow for support means to be inserted during construction of the rotary link 7, thereby reinforcing the snap posts 61,62,63. The enhanced durability of the prong members 61a, 61b, 62a, 62b, 63a, 63b is preferred due to the pinching and releasing during attachment of the slide pins 4.

Upon actuation of button 5a, said rotary link 7a rotates counter-clockwise and continues to rotate until catch 59 comes into contact with rotary link stop post 32a. Similarly, upon actuation of button 5b, said rotary link 7b rotates counter-clockwise and continues to rotate until catch 59 comes into contact with rotary link stop post 32b. Snap post 63 protrudes through eyelet hole 15 of slide pin 4, thus connecting said rotary link 7a with slide pin 4a, and said rotary link 7b with slide pin 4d.

FIGS. 44 through 50 illustrate the button 5 in further detail, wherein said button comprises an actuation portion 70 and a generally elongated link portion 81. Said actuation portion 70 further comprises a front surface 71 and a rear surface 72, wherein the user pushes the button 5 by pushing on the front surface 71 of the actuation portion 70. Said generally elongated link portion 81 further comprises a front link portion 79, a center link portion 76, a rear link portion 80, a protruding tail section 77, a living spring eyelet 74, a button guide eyelet 73, a rear link eyelet 75, and said living spring 78, wherein said living spring 78 protrudes through said living spring eyelet 74, and is attached to the front link portion 79 of said button 5. The living spring 78 protrudes through living spring holes 25a, 25b of the lid substrate 2. The button guide posts 29a, 30a protrude through said button guide eyelet 73 on button 5a, wherein the button guide posts 29b, 30b protrude through said button guide eyelet 73 on button 5b, thereby attaching said button 5a, 5b to lid substrate 2. The legs 65, 66 of the rotary link 7 protrude downward through said rear link eyelet 75 of the button 5, thereby connecting said button 5 with said rotary link 7.

FIGS. 51 through 54 show alternate views of the double hinge console latch 1. Moreover, further magnified views of the lock link 6 are shown, as well as a view some of the external and internal components of said lock link 6. These views show the sequence of the lock link 6 moving towards the passenger's side 109 in a direction bb.

FIGS. 55 through 61 illustrate the angled trigger 9, which is connected to the bin (not shown), and whose function has been described above in relation to the living spring 78 upon actuation of the button 5. The angled trigger 9 comprises a sloped portion 84, which comes into and out of contact with the contact end 10 of the living spring 78. Moreover, the angled trigger further comprises a top wall 85, a back wall 86, a front wall 87, a left side surface 88, a right side surface 92, and a bottom wall 93, wherein a curved portion 90 joins top wall 85 to back wall 86; a curved portion 91 joins top wall 85 with sloped portion 84; a curved portion 89 joins sloped portion 84 with front wall 87.

FIGS. 62 through 68 illustrate the extension spring 8, wherein the present invention comprises two extension springs 8a, 8b, wherein said extension spring 8 comprises a coiled central portion 94 terminating on each side by a hooks 95a, 95b, each connected to the coiled central portion 94 by a straight connecting portion 96, 97 respectively. Hook 95a attaches to extension spring post 28a (and also 28b for the second extension spring on the passenger's side). Hook 95b attaches to snap post 62 of rotary link 7a (and also 7b for the second extension spring on the passenger's side).

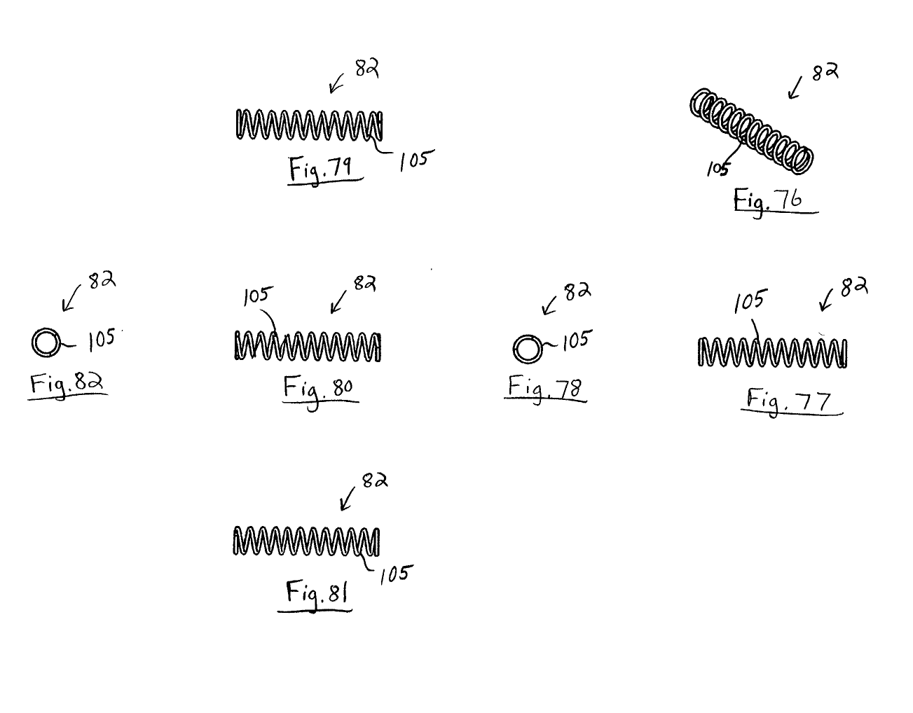

FIGS. 69 through 75 further illustrate the lock link 6. The lock link 6 comprises a push peg 83, a push end 110, a top surface 101, a bottom surface 100, a straight portion 99, a generally angled portion 102, and a stop 98. Wherein said stop 98 further comprises two angled support legs 103, 104. Lock link 6 fits onto said lock link housing 24 of lid substrate 2. The straight portion 99 of lock link 6 fits within rear straight wall 41 and front straight wall 43 of the lock link housing 24. A compression spring 82, comprising coils 105, further shown in FIGS. 76 through 82, is housed within the protruding guides 48, 49 located within lock link housing 24. The compression spring 82 is sandwiched between the passenger's side end wall 47 of the lock link housing 24 and the stop 98 of the lock link 6. The generally angled portion 102 of the lock link 6 fits within rear angled wall 42 and front angled wall 44 of the lock link housing 24.

When the button 5a is actuated, on the driver's side, causing rotary link 7a to rotate, the link 57 of rotary link 7a pushes against push end 110 of the lock link 6 thereby causing the lock link 6 to move in a direction bb towards the passenger's side. This movement allows the push peg 83 of the lock link 6 to move into notch 58 of rotary link 7b on the passenger's side, thereby preventing rotary movement of rotary link 7b, and causing the passenger's side of the latch assembly to remain in a neutral or locked position, and thus causing components of the passenger's side of the latch assembly to act merely as a hinge to allow the opening of the console lid. This is best seen in FIGS. 51 through 54.

These and other advantages of the present invention will be understood upon a reading of the Summary of the Invention, the Brief Description of the Drawing Figures and the Detailed Description of the Preferred Embodiment. Other modifications may be made consistent with the spirit and scope of the invention described herein.

We claim:

1. A double hinge console latch comprising:
a lid substrate having a first side and a second side;
a pair of slide members having a proximal end and a distal end, wherein a first slide member is disposed on said first side of said lid substrate and a second slide member is disposed on said second side of said lid substrate;
a pair of rotary links wherein a first rotary link is attached to said proximal end of said first slide member and a second rotary link is attached to said proximal end of said second slide member;
a plurality of slide pin assemblies, wherein a first pair of slide pin assemblies is attached to said first rotary link and a second pair of slide assemblies is attached to said second rotary link;
a lock link having a biasing means;
an extension spring having a first end and a second end; and
a camming means.

2. The double hinge console latch of claim 1, wherein said pair of slide members have an actuation member at said distal end and tangential portion at said proximal end.

3. The double hinge console latch of claim 2, wherein said slide members have a plurality of apertures there through, wherein said apertures on said slide members on located distally, centrally, and proximally.

4. The double hinge console latch of claim 3, wherein a living spring is attached to said distal aperture.

5. The double hinge console latch of claim 3, wherein said pair of rotary links further comprise legs which extend through said proximal apertures of said pair of slide members.

6. The double hinge console latch of claim 3, wherein said lid substrate further comprises two pairs of button guide posts, wherein said central apertures of said slide members attach.

7. The double hinge console latch of claim 4, wherein said camming means protrudes upward through a pair of living spring apertures of said lid substrate, wherein said camming means has a diagonal camming surface which contacts said living spring of said slide member, wherein said slide member is biased during actuation of the latch.

8. The double hinge console latch of claim 1, wherein said pair of rotary links further comprise a link portion for driving said lock link during actuation of the latch.

9. The double hinge console latch of claim 1, wherein said pair of rotary links further comprise a notched portion for attachment of said lock link.

10. The double hinge console latch of claim 1, wherein said pair of rotary links further comprise a catch to stop rotation of said rotary links during actuation.

11. The double hinge console latch of claim 10, wherein said lid substrate further comprises a pair of rotary link stop posts, wherein said catches of said rotary links engage and stop rotation of said rotary links during actuation of said latch.

12. The double hinge console latch of claim 1, wherein said pair of rotary links further comprise snap posts for attachment of said extension spring and said slide pin assemblies.

13. The double hinge console latch of claim 12, wherein said extension spring has a hook on said first end and said second end, wherein said first end hook attaches to said lid substrate and said second end attaches to said snap posts of said rotary link, wherein the rotation of said rotary link is biased during actuation of the latch.

14. The double hinge console latch of claim 13, wherein said lid substrate further comprises a pair of extension spring posts, wherein said first end hook of said extension springs attaches.

15. The double hinge console latch of any of the claims 8,9,10 or 12, wherein said lid substrate further comprises a pair of rotary center posts having wing elements which attach through a center hole of said rotary links.

16. The double hinge console latch of claim 1, wherein said slide pin assemblies comprise a rectangular mid-portion having a plurality of apertures, wherein said mid-portion is attached on a rear side by an elongated tail portion having at least one aperture and on a forward side to a curved protruding neck portion having at least one aperture, wherein said mid-portion is continuous on one side with a first side of a curved mid-section, wherein the second side of said mid-section is continuous with a tangentailly attached sloped section which terminates with a tapered section, wherein said tapered section is attached to a pin.

17. The double hinge console latch of claim 16, wherein said lid substrate further comprises a plurality of slide pin assembly housings having a base portion which house said slide pin assemblies, wherein said housings include a pin groove and a plurality of slide pin holes which guide said slide pins.

18. The double hinge console latch of claim 16, wherein said lid substrate further comprises a plurality of slide pin assembly housing guides, wherein said slide pin assembly housing guides comprise a plurality of slide pin guiding posts which protrude through said apertures of said mid-portion of said slide pin assembly.

19. The double hinge console latch of claim 1, wherein said lock link comprises a angled body section having a first end and a second end wherein said second end is continuous with a first end of a straight body section located tangentially to said first body section, wherein a second end of said straight body section has a push peg.

20. The double hinge console latch of claim 19, wherein said straight body portion has a top surface and a bottom surface, wherein a stop is attached to said bottom portion substantially centrally, wherein said stop has a pair of legs protruding parallel toward said first end of said straight body portion.

21. The double hinge console latch of claim 20, wherein said first side of said lid substrate has a centrally located lock link housing wherein said lock link housing comprises a forward wall and a rear wall forming a straight portion and an angled portion corresponding to said straight portion and said angled portion of said lock link, wherein said lock link housing further comprises a passengers side wall, a central wall and a drivers side wall within and perpendicular to said forward wall and said rear wall, wherein said passengers side wall, said central wall and said drivers side wall are shorter then said forward wall and said rear wall, wherein said inner walls of said housing support said link lock.

22. The double hinge console latch of claim 21, wherein said passengers side wall of said link lock housing has a pair of protruding guides attached perpendicular to said passenger side wall, wherein said biasing means is a compression spring positioned so as to bias movement of said lock link during actuation of the latch.
